(19) United States
(12) Patent Application Publication
(10) Pub. No.: US 2014/0156845 A1
(43) Pub. Date: Jun. 5, 2014

(54) MECHANISM TO BLOCK WEB SITES USING RETURN TRAFFIC

(71) Applicant: THOMSON LICENSING, (US)

(72) Inventors: David John WEAVER, Fishers, IN (US); Mark Allen McCleary, Indianapolis, IN (US)

(73) Assignee: THOMSON LICENSING, Issy de Moulineaux (FR)

(21) Appl. No.: 13/693,288

(22) Filed: Dec. 4, 2012

(51) Int. Cl. H04L 12/24

(52) U.S. Cl. CPC H04L 41/00
USPC 709/225

(57) ABSTRACT

A method and apparatus for blocking websites using return traffic are described including receiving a request for access to a blocked website from a user, determining if the request includes a first domain name, transmitting the request if the request does not include the first domain name, receiving return traffic in response to the transmitted request, determining if a second domain name in the return traffic matches the first domain name, blocking access to the website if the first domain name and the second domain name match and discarding the return traffic if the access is blocked.

### FIELD OF THE INVENTION

The present invention relates to a reliable mechanism to block web sites. In particular the present invention does a better job of preventing unauthorized access by checking traffic returned from the internet.

### BACKGROUND OF THE INVENTION

In multicast and broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

Most routers these days include a feature to allow administrators to block websites from systems served by the router. This allows a parent to restrict access to sites they may feel would endanger or otherwise adversely affect their child. One problem, however, is that the routers generally check the outgoing requests to decide whether or not to block the site. This allows a savvy user to bypass, or “trick”, the router's restrictions by using an IP address instead of the domain name or even using an external site that redirects them to the blocked content. Children growing up with the internet now are becoming more technology savvy, rendering the traditional site blocking mechanisms all but useless.

Typically a router connects like and unlike networks such as WANs, MANs, LANs etc. That is, typically, a router is an interface between networks. Typically, a gateway provides an entry or exit into/out of a communications network. The terms router and gateway are used interchangeably herein. A home gateway is simply a gateway device that is used in a home/residential environment. A home gateway as used herein includes the functionality of both a router and a gateway and is used to connect the home network to networks outside the home such as the Internet or cable service provider or satellite provider or other networks provided by a communications provider.

Conventional implementations currently available from the open source (GPL) community and many hardware vendors do a check on the traffic going from a device on the LAN to the connection to the internet, the WAN interface. These checks are normally simple string comparisons to a list of strings entered by the router's administrator. For instance, a parent wants to block all access to the website Iwanttoblockthissite.com. The string would be entered into the router's configuration mechanism. That string would be stored by the router and the gateway would then compare all traffic destined for the internet to see if the website Iwanttoblockthissite.com appears. If the string appears in traffic destined for the internet, that traffic would be stopped and, sometimes, the user would be notified that the site was blocked by the administrator.

### SUMMARY OF THE INVENTION

The present invention relates to a reliable mechanism to block web sites. In particular the present invention does a better job of preventing unauthorized access by checking traffic returned from the internet.

A method and apparatus for blocking websites using return traffic are described including receiving a request for access to a blocked website from a user, determining if the request includes a first domain name, transmitting the request if the request does not include the first domain name, receiving return traffic in response to the transmitted request, determining if a second domain name in the return traffic matches the first domain name, blocking access to the website if the first domain name and the second domain name match and discarding the return traffic if the access is blocked.

### BRIEF DESCRIPTION OF THE DRAWINGS

The present invention is best understood from the following detailed description when read in conjunction with the accompanying drawings. The drawings include the following figures briefly described below:

FIG. 1 illustrates a system for communicating between a home and the internet, shown both WAN (internet) and LAN connection through a gateway device in accordance with the principles of the present invention.

FIG. 2 is a block diagram of an exemplary gateway device in accordance with the principles of the present invention.

FIG. 3 is a flowchart of an exemplary implementation including the nominal website block for communications from the LAN device as well as the new return traffic check and website block in accordance with the principles of the present invention.

### DETAILED DESCRIPTION OF THE PREFERRED EMBODIMENTS

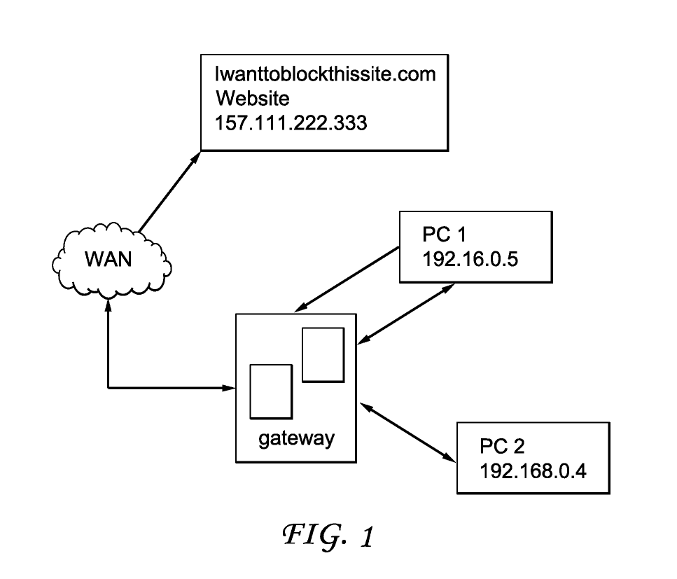

FIG. 1 illustrates a system for communicating between a home and the internet, shown both WAN (internet) and LAN connection through a gateway device in accordance with the principles of the present invention. Using FIG. 1 and the above example using the fictional website Iwanttoblockthissite.com, some of the aforementioned savvy users might be able to find that the site can be accessed directly by using its' IP address. For instance, the website Iwanttoblockthissite.com might resolve to the host at “157.111.222.333”. The user may then be able to bypass the block by entering that address into their browser directly. They can then freely access the site that the parent wanted to restrict simply because they did not use the NAME that was intended to be blocked. The parents of the child(ren) user(s) of PC1 elect to block the website Iwanttoblockthis site.com. The child(ren) user(s) of PC1 attempt to access the blocked website by sending a request to access the blocked website using the domain name of the website (Iwanttoblockthissite.com). When the request reaches the gateway, the gateway blocks access to the blocked website. The parents of the child(ren) user(s) of PC2 elect to block the website Iwanttoblockthis site.com. The child(ren) user(s) of PC2 attempt to access the blocked website by sending a request to access the blocked website using the IP address of the blocked website (157.111.222.333). When the request reaches the gateway, the gateway permits access to the blocked website because in current gateways the portion of the gateway that checks for blocked websites only checks the request against the domain NAME. The portion of conventional gateway implementations that checks for blocked websites does not check IP addresses.

Websites do currently use their NAME in the return traffic in order to “self-promote” and have the browsers include that name for display. This practice can be exploited and used to perform a second check for site restrictions. The router can easily examine packets returned from the internet in a similar way to the outgoing traffic to see if the name matches one that the administrator put in the blocked list. The same string compare that is used on outgoing traffic can be used on incoming traffic to better enforce the restriction.

The present invention is for a gateway implementation that receives an IP address for a blocked website from PC 2. The present gateway implementation transmits this request to the blocked website and receives return traffic from the blocked website. It is this return traffic that is checked by the present invention to see if the domain NAME in the return traffic matches the blocked website NAME. If the names match then the return traffic is not forwarded to PC 2 and access to the blocked website is denied.

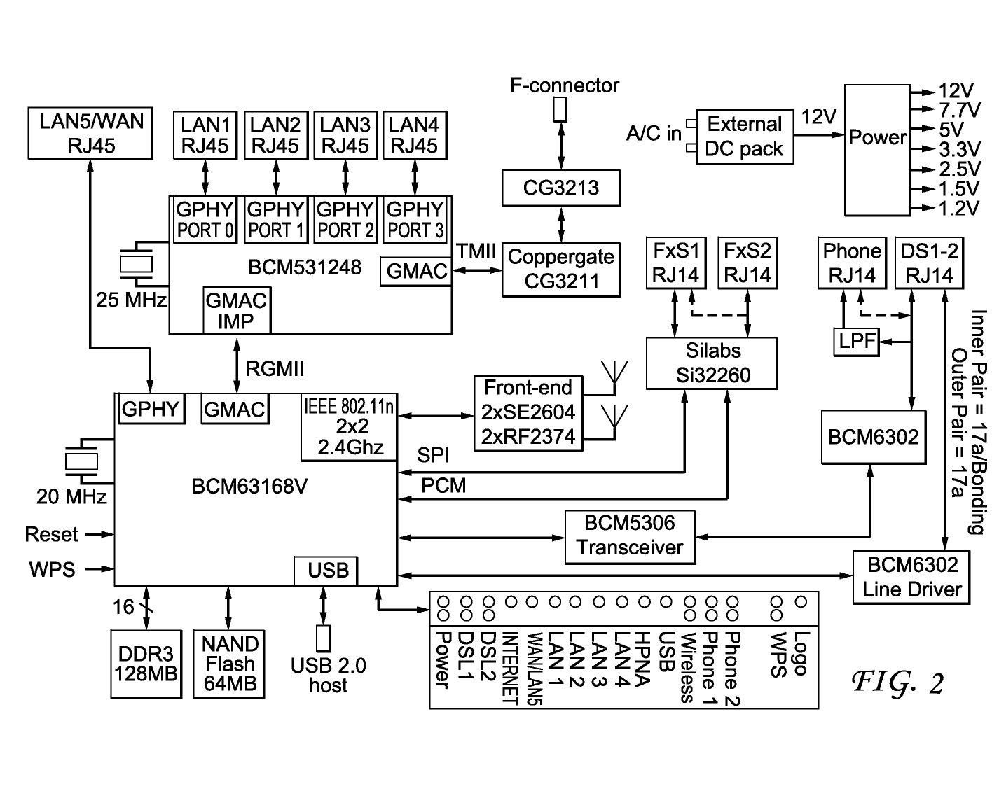

FIG. 2 is a block diagram of an exemplary gateway device in accordance to the principles of the present invention. The main controller is the block labeled BCM63168V. That is, the present invention may be implemented as a program executable on processor/controller BCM6318V. An alternative implementation may be implementation on an application specific integrated circuit (ASIC) or on a field programmable gate array (FPGA) or an equivalent device. The BCM63168V integrated circuit (IC) will receive and process all data traffic from the LAN side and the WAN side and would include any “blocks” associated with incoming LAN traffic (going out to internet) and then also includes the new “blocks” associated with incoming WAN traffic (interception before being transmitted to LAN device). The present invention is for a gateway implementation that receives an IP address for a blocked website from a PC. The present gateway implementation transmits this request to the blocked website and receives return traffic from the blocked website. It is this return traffic that is checked by the present invention (the BCM63168V) to see if the domain NAME in the return traffic matches the blocked website NAME. If the names match then the return traffic is not forwarded to the requesting PC and access to the blocked website is denied.

In FIG. 2 the home gateway (apparatus) for blocking websites using return traffic includes a front-end for wireless communications and a transceiver (BCM6306) for wired line communications. All reception and transmission signals pass through either the front-end or the transceiver. That is, the means for receiving a request for access to a blocked website from a user is via either the front-end or the transceiver. The means for determining if the request includes a first domain name is within the controller (BCM63168V) and may be in software (a program) executed on said controller. The means for transmitting the request if the request does not include the first domain name is either the front-end or the transceiver. The means for receiving return traffic in response to the transmitted request is either the front-end or the transceiver. The means for determining if a second domain name in the return traffic matches the first domain name is within the controller (BCM63168V) and may be in software (a program) executed on said controller. The means for blocking access to the website if the first domain name and the second domain name match is within the controller (BCM63168V) and may be in software (a program) executed on said controller. The means for discarding the return traffic if the access is blocked is within the controller (BCM63168V) and may be in software (a program) executed on said controller. The means for determining, based on the first domain name, if the website is blocked is within the controller (BCM63168V) and may be in software (a program) executed on said controller. The means for blocking access to the website if the website is determined to be blocked is within the controller (BCM63168V) and may be in software (a program) executed on said controller. The means for determining, based on the first domain name, if the website is blocked is within the controller (BCM63168V) and may be in software (a program) executed on said controller. The means for transmitting the request, if the website in the request is determined not to be blocked, is either the front-end or the transceiver. The means for receiving return traffic in response to the transmitted request is either the front-end or the transceiver. The means for forwarding the return traffic to the user is either the front-end or the transceiver. The means for transmitting a message to the user that access to the requested website is blocked is either the front-end or the transceiver.

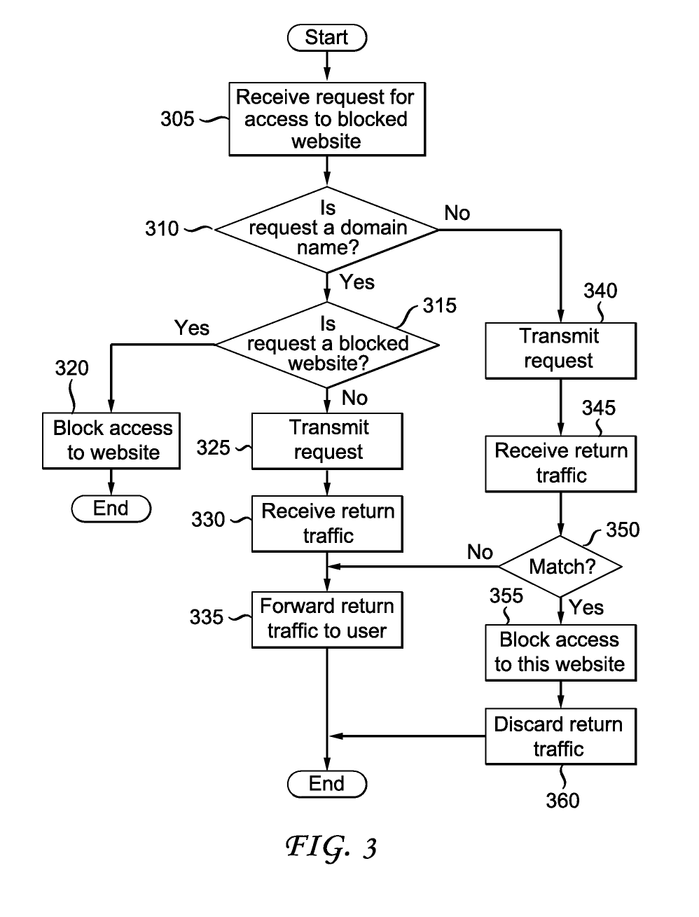

FIG. 3 is a flowchart including the website block for communications from the LAN device as well as the new return traffic check and website block in accordance with the principles of the present invention. At 305 the gateway of the present invention receives a request to access a website. At 310 a test is performed to determine if the received request includes a domain name of the requested website. If the request includes a domain name then at 315, a test is performed to determine if the requested website access is to a blocked website. If the received request is to a blocked website then at 320, access to the website is blocked and the process ends. This may include transmitting a message to that effect to the user. If the received request is not to a blocked website then at 325 the request is transmitted to the requested website. At 330, return traffic (from the request) is received. At 335, the received return traffic is forwarded to the user.

If the request does not include a domain name then at 340, the received request is transmitted to the requested website. At 345, return traffic (from the request) is received including the domain name of the website. At 350, a test is performed to determine if the domain name in the return traffic matches the name of the blocked website. If the domain name in the return traffic matches the name of the blocked website then at 355, access to this website is blocked. AT 360 the return traffic is discarded. This may include transmitting a message to that effect to the user. If the domain name in the return traffic does not match the name of the blocked website then processing proceeds to 335.

It is to be understood that the present invention may be implemented in various forms of hardware, software, firmware, special purpose processors, or a combination thereof Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed Given the teachings herein, one of ordinary skill in the related art will be able to contemplate these and similar implementations or configurations of the present invention.

1. A method for blocking websites using return traffic, said method comprising:
receiving a request for access to a blocked website from a user;
determining if said request includes a first domain name;
transmitting said request if said request does not include said first domain name;
receiving return traffic in response to said transmitted request;
determining if a second domain name in said return traffic matches said first domain name;
blocking access to said website if said first domain name and said second domain name match; and
discarding said return traffic if said access is blocked.

2. The method according to claim 1 further comprising:
determining, based on said first domain name, if said website is blocked; and
blocking access to said website if said website is determined to be blocked.

3. The method according to claim 1, further comprising:
determining, based on said first domain name, if said website is blocked;
transmitting said request if said website in said request is determined not to be blocked;
receiving return traffic in response to said transmitted request;
forwarding said return traffic to said user.

4. The method according to claim 1, further comprising transmitting a message to said user that access to the requested website is blocked.

5. The method according to claim 1 wherein said blocking is determined by parental controls.

6. An apparatus gateway for blocking websites using return traffic, comprising:
means for receiving a request for access to a blocked website from a user;
means for determining if said request includes a first domain name;
means for transmitting said request if said request does not include said first domain name;
means for receiving return traffic in response to said transmitted request;
means for determining if a second domain name in said return traffic matches said first domain name;
means for blocking access to said website if said first domain name and said second domain name match; and
means for discarding said return traffic if said access is blocked.

7. The apparatus according to claim 6 further comprising:
means for determining, based on said first domain name, if said website is blocked; and
means for blocking access to said website if said website is determined to be blocked.

8. The apparatus according to claim 6, further comprising:
means for determining, based on said first domain name, if said website is blocked;
means for transmitting said request if said website in said request is determined not to be blocked;
means for receiving return traffic in response to said transmitted request;
means for forwarding said return traffic to said user.

9. The apparatus according to claim 6, further comprising means for transmitting a message to said user that access to the requested website is blocked.

10. The apparatus according to claim 6, wherein said means for blocking is determined by parental controls.

11. The apparatus according to claim 6, wherein said apparatus is a home gateway.
